(19) United States
(12) Patent Application Publication
(10) Pub. No.: US 2012/0236397 A1
(43) Pub. Date: Sep. 20, 2012

(54) Two Mirror Optical System

(75) Inventor: Daniel Gene Smith, Tucson, AZ (US)

(73) Assignee: Nikon Corporation, Tokyo (JP)

(21) Appl. No.: 13/418,850

(22) Filed: Mar. 13, 2012

Related U.S. Application Data
(60) Provisional application No. 61/465,247, filed on Mar. 15, 2011.

(51) Int. Cl. G02B 17/08; G02B 5/08

(52) U.S. Cl. 359/365; 359/850

(57) ABSTRACT

A new and useful optical system is provided, which is particularly useful as an optical relay for an aerial imaging system (AIS). The optical system preferably comprises a two element catadioptric lens where a beam transmitted by makes two reflections before leaving the first solid glass (catadioptric) element, then reflects off the second (mirror) element, makes a fourth reflection off the outside surface of the first element and then passes through a hole in the center of the second element. When the optical system is used as an AIS relay, it substantially captures the NA of the projection lens with which it is associated, and simplifies the structure of the AIS relay. In addition, the AIS relay is configured to minimize the affects of stray light.

### RELATED APPLICATION/CLAIM OF PRIORITY

This application is related to and claims priority from U.S. Provisional application Ser. No. 61/465,247, filed Mar. 15, 2011, entitled Two Mirror AIS Relay Lens, which provisional application is incorporated by reference herein.

### INTRODUCTION

The present invention provides a new and useful optical system, which is particularly useful as an optical relay for an aerial image sensor (AIS).

An aerial image sensor (AIS) is an optical system with an AIS relay (also referred to as a relay lens) that is associated with an optical projection lens. The AIS is operated in conjunction with the optical projection lens, and is positioned at the image plane of the projection lens. Basically, an AIS is used to test how well the projection lens is imaging a reticle to a substrate. The AIS has an AIS slit that is rigidly attached to the AIS relay, and the AIS system is scanned, with the slit, relative to the aerial image produced by the projection lens. The AIS relay transmits radiation received through the AIS slit to a single detector element, and by the quality of the signal received by the detector provides information about the imaging characteristics of the optical projection lens. The basic features and functions of an AIS are generally well known to those in the art. However, in applicant's experience, the numerical aperature (NA) of an AIS relay lens may be considerably less than the NA of the projection lens with which it is associated, particularly in high NA water immersion lithography systems where it is difficult to design a compact and light weight AIS relay that also captures the full NA, and therefore does not obtain as much information as it could from the radiation transmitted by the AIS slit. Also, to produce a good image the slit with the full NA of a water immersion lithography lens (NA˜=1.35) the AIS relay must be fairly complex relative to the present invention.

Having an NA smaller than the projection lens, means that the AIS system is not gathering as much information abou the projection lens image quality as it could because much of the light transmitted by the AIS slit will not reach the detector. Also, an AIS relay that is more complex than it needs to be, will likely take up more space, weigh more than it has to, and cost more to manufacture. In another AIS system of the applicant, described in U.S. application Ser. No. 13/309,526, filed Dec. 1, 2011, entitled “Compound Parabolic Collectors for Projection Lens Metrology” and incorporated by reference herein, a compound parabolic collector is used to collect all of the light from an AIS slit and relay it to a large detector, via a fiber bundle that is several millimeters in diameter.

Thus, from applicant's experience, it is useful to provide an AIS with a relay that (i) substantially captures the NA of the projection lens with which it is associated, and (ii) simplifies the structure of the AIS relay lens. In addition, in applicant's experience, it is also desirable to minimize adverse affects of stray light in such a relay.

### SUMMARY OF THE PRESENT INVENTION

According to the present invention, a new and useful optical system is provided, which is particularly useful as a relay for an AIS system, because it addresses the issues described above. When the optical system of the invention is used as an AIS relay, the relay substantially captures the NA of the projection lens with which it is associated, and simplifies the structure of the AIS relay. In addition, the AIS relay is configured to minimize the affects of stray light.

With a preferred version of the present invention, the problems of insufficient NA and lens complexity in an AIS relay are solved by imploying a two element catadioptric lens where the beam transmitted by the AIS slit makes two reflections before leaving a first solid glass (catadioptric) element, then reflects off a second (mirror) element, makes a fourth reflection off the outside surface of the first element and then passes through a hole in the center of the second element, where the transmitted radiation either incounters a detector, or is relayed to a detector with an addition optical system (e.g., a fiber bundle).

Further features of the present invention will become apparent from the following detailed description and the accompanying drawings.

### BRIEF DESCRIPTION OF THE DRAWINGS

FIG. 1 is a schematic, exploded illustration of the basic components of an aerial imaging system (AIS), with which the present invention is particularly useful; and

FIGS. 2 and 3 are schematic illustrations of an an optical system of the present invention, as used as an AIS relay.

### DETAILED DESCRIPTION

As described above, the present invention provides a new and useful optical system, which is particularly useful as an AIS relay. The optical system of the invention is described herein as an AIS relay for an AIS system, and from that description the manner in which the optical system can be used for various types of metrology systems, as well as for other applications will be clear to those in the art.

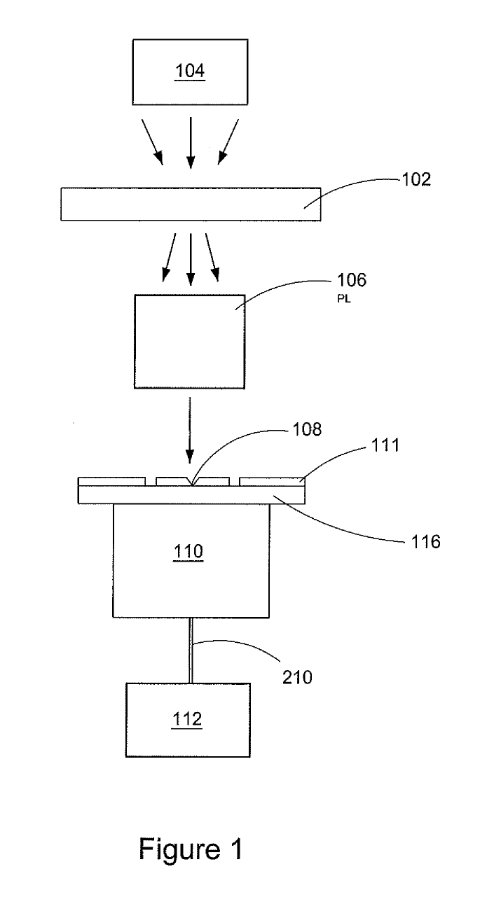

The optical system of the present invention is particularly useful as an AIS relay in an aerial image sensor (AIS) of the type shown in FIG. 1. In a typical photolithographic image system, a mask (or reticle) has a pattern that is illuminated and projected to a substrate (e.g. a substrate for producing a semi conductor wafer). The image that is projected to the substrate (essentially at the image plane of the projection lens) is known as the “aerial image” or AI, That aerial image would typically be a two dimensional image of a portion of an electronic circuit, which would be imaged onto photoresist on the substrate. The photoresist is then developed, to produce a pattern that is used in defining the electronic circuit on the substrate. The AIS system is not usually used to image the same pattern as that being printed on the substrate. Instead it is used to look at a special pattern designed specifically for the AIS system and usually placed on the periphery of the reticle or on a dedicated reticle.

The optical system of the present invention is provided as an AIS relay 110 in the AIS system 100 of the type shown in FIG. 1. In the AIS 100, a mask (or reticle) 102 is illuminated by a source 104. The mask 102 would have a special pattern designed for the AIS measurement, as would be recognized by those in the art. The AIS system 100 can be designed, e.g. according to U.S. application Ser. No. 09/841,044, filed Apr. 25, 2001 (published as US published application 2002/0041377), which is incorporated herein by reference. The system 100 utilizes the mask or reticle 102 that is illuminated by the source 104 (e.g an argon fluoride laser that produces light in the 193 nm wavelength range) and the image of the mask is directed by projection optics 106 (also referred to as projection lens PL) to produce the aerial image. A glass component 116 with a slit 108 is supported and positioned by a stage (not shown) that is well known to those in the art. The AIS slit 108 is rigidly attached to the AIS relay 110 and the AIS system is scanned with the AIS slit relative to the aerial image. The AIS relay 110 transmits radiation received through the AIS slit to a single detector element, and by the quality of the signal received by the detector provides information about the imaging characteristics of the optical projection lens.

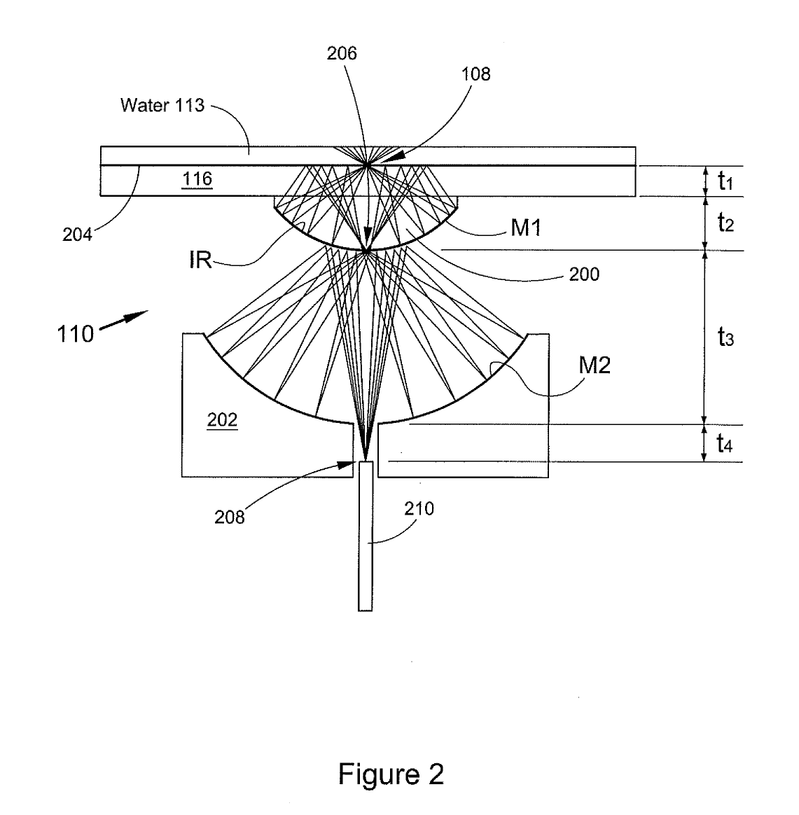

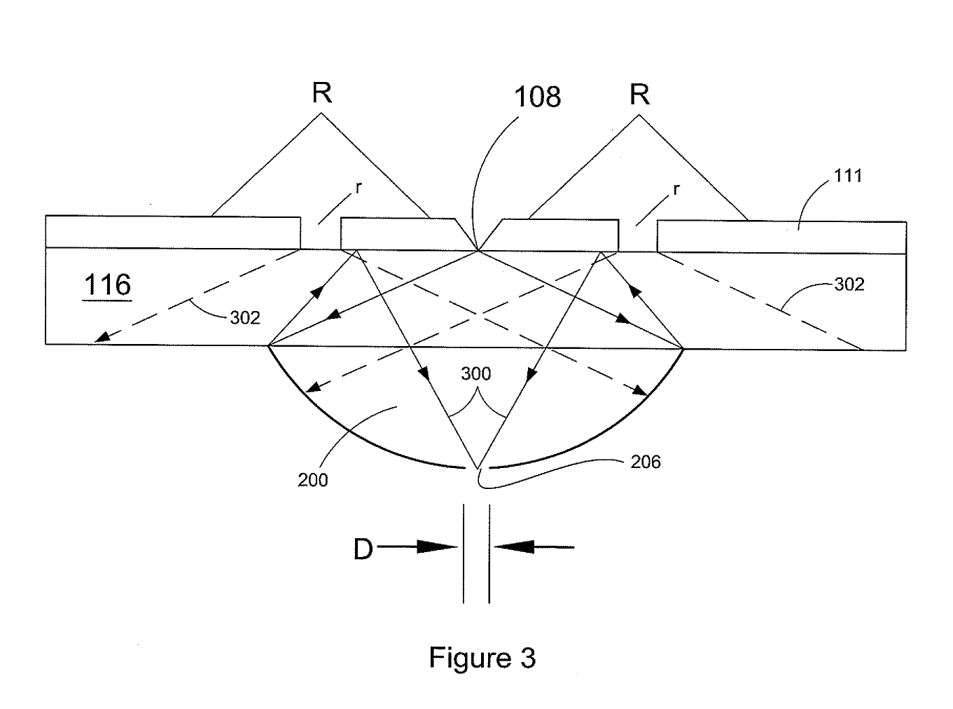

According to the present invention, the AIS relay 110 is configured to substantially capture the NA of the projection lens 106 with which it is associated, and the configuration of relay 110 is also designed to simplify the structure of the AIS relay. In addition, the AIS relay 110 is configured to minimize the effects of stray light, The AIS relay 110, in accordance with the present invention, is shown in more detail in FIGS. 2 and 3.

With a preferred version of the present invention, the problems of insufficient NA and lens complexity in an AIS relay are solved by employing a two element catadioptric lens as the relay 110. As seen in FIG. 2, the glass component 116 (which is preferably fused silica) has a water layer 113 that is similar to a water layer that would typically be found in a water immersion lithography system. The relay 110 includes a transparent glass element 200 that is bonded to (or formed in one piece with) the fused silica component 116, to form a transparent solid body with plano-convex shape. The planar portion is the planar surface 204 of the fused silica component 116 at the interface of the fused silica and the water layer 113. That planar surface 204 also has the slit or opening 108, as described further in connection with FIG. 3. The first element 200 has an external mirror coating forming a convex external mirror surface M1, and an internal concave reflective surface IR. The element 200 also has a radiation emitting portion as an opening 206 in the reflective coating of the convex mirror surface M1. The relay 110 also includes a second element 202 having a concave external mirror surface M2. The second element 202 has a radiation emitting portion (opening) 208 surrounded by the concave mirror surface M2.

Thus, the optical system of the invention, when forming the relay 110, comprises a first element (the element 200 coupled to, or formed in one piece with the fused silica layer 116) having a transparent solid body with plano-convex shape; and a second element (the element 202) having a concave mirror surface M2. The convex surface of the first element 200 has a convex mirror surface M1, and radiation passing through the slit 108 is reflected by an internal concave portion IR of the first element, reflected by the internal plano surface 204 of the first element, transmitted though the radiation emitting opening 206 of the first element, reflected by the concave mirror surface M2 of the second element, and reflected externally by the convex mirror surface M1 of the first element. Radiation reflected by the convex mirror surface M1 of the first element passes through the radiation emitting portion 208 of the second element. The radiation passing through the radiation emitting portion 208 of the second element is directed to the detector 112, e.g. through a fiber bundle 210 extending into and from the second element 202.

Accordingly, when the optical system is used as an AIS relay, the beam transmitted by the AIS slit 108 makes two reflections before leaving the first solid glass (catadioptric) element (116+200), then reflects off the mirror M2, makes a fourth reflection off the mirror M1 on the outside surface of the first element and then passes through the second element 202, where the transmitted radiation either encounters the detector 112, or is relayed to the detector 112 (e.g. with the fiber bundle 210 that extends through element 202 to the opening 208).

The AIS relay 110 provides a two element catadioptric lens configured to provide an NA at (or close to, or even greater than) the NA of the projection lens with which it is associated. Also, the AIS relay 110 is configured to substantially capture the full projection lens NA, and is relatively simple because it essentially comprises a 2 element catadioptric lens (preferably the solid glass element (116+200) with the internal reflector portion IR and the external reflector MD. The AIS relay minimizes stray light by the reflective ring 111 about the AIS slit 108 that is configured to reduce the effect of stray light. Specifically, As shown in FIG. 3, a reflective ring 111 includes a reflective region R that surrounds the AIS slit 108, and has a boundary r that forms a transmitting region. In FIG. 3 the transmitting region r is annular, but the transmitting region can also have other configurations, as will be clear to those in the art. Thus, light about the slit 108 is reflected by the reflective region R, and transmitted by the transmitting region r. With the AIS slit 108, the two element catadioptric lens configuration shown and described herein, the reflective region R, and the transmitting region r, the signal beam transmitted by the slit converges to the opening 206 in the element 200, as shown by the beam paths shown at 300 in FIG. 3. The beam paths shown at 302 in FIG. 3 represent the beam paths of the flare beam (the beam transmitted by the transmitting anulus r, which is in effect stray light). The relay lens 110 of the invention is designed to minimize the likelihood of stray light being directed to the area shown at D. By designing the optical system, the reflecting region R and the transmitting region r so that the dimension D (the size of the opening 26) is made as small as possible, the likelihood of stray light being transmitted through the opening 206 in the element 200 is minimized, thereby minimizing the effects of stray light.

It should be noted that the convex surface of element 200 which is mirrored to form the external convex mirror M1 may be spherical or aspherical. The concave surface of element 202 that is mirrored to form the concave mirror M2 can be spherical, or aspherical

When the two element catadioptric lens forming the optical system of the present invention is used as the AIS relay 110, issues of insufficient NA and lens complexity in an AIS relay are solved, because the beam transmitted by the AIS slit 108 (FIG. 3) makes two reflections before leaving the first solid glass (catadioptric) element (116+200), then reflects off the second (mirror) element M2, makes a fourth reflection off the outside mirror M1 of the first element, and then passes through the second element 202, where the transmitted radiation either is directed to the detector 112, or is relayed to the detector with an addition optical system (e.g., the fiber bundle 210).

As seen from the foregoing description, the basic idea behind the present invention is to capture the full projection lens NA, and keep the imaging system as simple as possibly using only two elements.

As shown in FIGS. 2 and 3, the first element actually comprises two pieces of glass; the fused silica plane parallel plate 116, and the plano-convex lens element 200. It is not necessary to construct this element as two separate pieces, but doing so is advantageous from a manufacturing perspective, and because it allows for a very large substrate to contain the slit pattern. In the cases where the first element is made from two glass pieces, the plano-convex lens element 200 must be secured to the plate 116. This can be done, e.g., by optical contacting, since cements are not typically available in the wavelength range in which the relay is designed to operate, and because clamping will result in reduced performance, though either cementing or clamping are permissible within the present invention.

As an example, applicant's formula for the prescriptions for elements 200 and 202 (where the surface M1 of element 200 and the surface M2 of element 202 are aspheric) is

$$z = \frac{{r}^{2} / R}{1 + \sqrt{1 - ( 1 + k ) {r}^{2} / {R}^{2}}} + {Ar}^{2} + {Br}^{4} + {Cr}^{6}$$

Where r is the radial distance from the optical axis, R is the radius of curvature, k is the conic constant, and A, B, and C are known as aspheric coefficients. For the convex reflective surface M1 of element 200 (where that surface is aspheric) applicant provides the following constants,
R=−11.1076 mm
K=−0.14068
A=−1.16460e-5 mm̂−1
B=−2.03353e-9 mm̂−3
C=7.07648e-10 mm̂−5

For the concave reflective surface M2 of element 202 (where that surface is aspheric) applicant provides the following constants
R=−10.9670 mm
K=−0.073543
A=1.36997e-5 mm̂−1
B=5.59081e-8 mm̂−3
C=−3.45185e-9 mm̂−5
   The thickness t1 of the fused silica plate (116) is 3 mm. The thickness t2 of the first element 200, constructed from fused silica, is 5.3284 mm, with an edge thickness of 1.24 mm.
   The air space t3 between the vertex of the first element 200 and the second element 202 is 9.3097 mm, and the distance t4 from the vertex of the second element 202 and the final image or fiber bundle 210 is 5.5077 mm.

An advantage of embodiments where the first element is spherical, unlike the example embodiment (assphere+asphere) is that the spherical surface can be adhered to the plate without concern for tip and tilt, so that once the first element is characterized, aligned, and adhered to the plate, the rest of the system (the asphere and fiber bundle) provide a number of compensators for any differences from the intended design; the asphere can be re-optimized, and/or repositioned, and the fiber can be positioned to maximize the captured energy.

It is noted that an all spherical design has poorer imaging performance and thus requires a larger fiber bundle, but will have looser tolerances all around. Alternatively, an all-asphere design like example above can provide much better imaging performance and so it can reduce the size of the fiber bundle, possibly requiring only a single fiber. If radiation drift becomes an issue, it may be possible to reduce the effects of draft by using a single light transmitting rod, in place of the fiber bundle.

Accordingly, the foregoing description provides a new and useful optical system, which is particularly useful as an AIS relay that substantially captures the NA of the projection lens with which it is associated, and simplifies the structure of the AIS relay. In addition, the AIS relay is configured to minimize the affects of stray light. With the foregoing disclosure in mind, the manner in which an optical system can be designed as an AIS relay that substantially captures the full NA of a projection lens, while simplifying the AIS relay structure, will be apparent to those in the art. In addition, the manner in which the optical system can be used for various types of metrology systems, as well as for other applications will be clear to those in the art.

1. An optical system comprising:
a. a first element having a transparent solid body with plano-convex shape, and
b. a second element having a concave mirror surface;
c. the first element having an internal plano reflecting surface, an internal concave reflecting surface and a convex surface comprising a convex mirror surface, and
d. wherein the optical system is configured such that radiation passes through the first element, is reflected by the internal concave surface of the first element, reflected by the internal plano surface of the first element, reflected by the concave mirror surface of the second element, and reflected by the convex mirror surface of the first element.

2. The optical system according to claim 1, the first element having a opening formed on the plano surface.

3. The optical system according to claim 1, the first element having a radiation emitting portion surrounded by the convex mirror surface.

4. The optical system according to claim 3, wherein radiation reflected by the internal plano surface passes through the radiation emitting portion.

5. The optical system according to claim 1, the second element having a radiation emitting portion surrounded by the concave mirror surface.

6. The optical system according to claim 5, wherein radiation reflected by the convex mirror surface of the first element passes through the radiation emitting portion.

7. The optical system according to claim 6, further comprising a radiation transmitting fiber bundle arranged near the radiation emitting portion of the second element.

8. The optical system according to claim 7, wherein the first element having a second radiation emitting portion surrounded by the convex mirror surface.

9. The optical system according to claim 3, wherein radiation reflected by the internal plano surface passes through the second radiation emitting portion.

10. An AIS relay for a projection optics imaging system with a projection lens that projects an image, the AIS relay configured with a numerical aperture (NA) that substantially captures the full NA of the projection lens with which it is associated.

11. The AIS relay of claim 10, wherein the AIS relay comprises an AIS slit to which a beam is projected from the projection lens, and a two element catadioptric lens configuration that optically processes and transmits the beam projected to the slit by the projection lens.

12. The AIS relay of claim 11, wherein a reflective region about the AIS slit comprises a boundary that forms a transmitting region configured to reduce the effect of stray light from the projection lens.

13. The AIS relay of claim 11 wherein the two element catadioptric element is configured and oriented such that a beam transmitted by the AIS slit makes two reflections before leaving the first (catadioptric) element, then reflects off an external reflector of the second catadioptric element, makes a fourth reflection off the outside surface of the first catadioptric element and then passes through an opening in the center of the second catadioptric element

14. The AIS relay of claim 13, wherein the first catadioptric element comprises an internal concave reflector and a surface mirror that is an external convex reflector.

15. The AIS relay of claim 14, wherein the second catadioptric element comprises a glass element with a concave surface mirror that is the external reflector of the second catadioptric lens.

16. The AIS relay of claim 15, wherein the AIS relay is configured such that the beam transmitted by the AIS slit makes two reflections before leaving the first solid glass catadioptric element through an opening in the first solid glass element, then reflects off the second (mirror) element, makes a fourth reflection off the outside surface of the first element and then passes through a hole in the center of the second element.

17. The AIS lens of claim 16, wherein the first element comprises two pieces of glass; a plane parallel plate, and a plano-convex lens.

18. The AIS lens of claim 17, wherein the plano convex lens has a spherical surface and an asphere for the concave element.

19. The AIS relay of claim 18 wherein AIS relay is configured to minimize the effects of stray light, by minimizing the size of the opening in the reflective coating in the first solid glass element.
